(19) United States
(12) Patent Application Publication
(10) Pub. No.: US 2004/0130285 A1
(43) Pub. Date: Jul. 8, 2004

(54) Obstruction detector for movable vehicle members

(76) Inventor: Yann Le Gallo, Orleans (FR)

Correspondence Address: CARLSON, GASKEY & OLDS, P.C., 400 WEST MAPLE ROAD, SUITE 350, BIRMINGHAM, MI, 48009, US

(21) Appl. No.: 10/673,027

(22) Filed: Sep. 26, 2003

(30) Foreign Application Priority Data
Sep. 26, 2002 (FR) 02 11 926

(51) Int. Cl. H02P 3/00

(52) U.S. Cl. 318/466; 318/480

(57) ABSTRACT

A system detects an obstruction in the path of a vehicle openable member, such as a window. The system comprises a direct detector of the obstruction and an indirect detector of the obstruction. The indirect detector detects force exerted by the obstruction on the openable member, while the direct detector uses an image of the opening to detect an obstruction. The indirect detector provides the direct detector with openable member position information, which is used in the direct detector to refine the detection process and increase its reliability. The indirect detector can also interrupt the movement of the openable member if the direct detector malfunctions.

### REFERENCE TO RELATED APPLICATIONS

The present invention claims the benefit of French Patent Application No. 02 11 926, filed Sep. 26, 2002.

### TECHNICAL FIELD

This invention relates to vehicles and more specifically to detecting obstructions in a moving operable vehicle member, such as a window or sunroof.

### BACKGROUND OF THE INVENTION

Vehicles are commonly fitted with electrically powered window winders. In this case, standards require that the travel of the window be interrupted if an obstruction is present. Some vehicle standards, for example, require that the maximum pinching force on obstructions of 20 or 65 N/mm is less than 100 N.

One example of a proposed mechanical anti-trapping solutions are mentioned in FR-B-2 675 613. Another example is shown in U.S. Pat. No. 5,955,854 (“the '854 patent”), which proposes an obstruction detection device for windows or other types of power driven openable member. In this example, an emitter/receiver with infrared diodes is placed in the vicinity of the front lower corner of the window. The detection is based on the increase in the reflected energy if an obstruction is present above the window. More specifically, when the window is closed automatically, the emitter emits a series of 38 kHz pulses that are frequency modulated over a lower frequency pulse train with a period P and a 50% duty cycle. The duration of the low frequency pulses is measured at the receiver output. If there is no obstruction, the duration of a pulse at the receiver output is substantially half of the period P. If there is an obstruction, the duration of the receiver output pulse is longer. The obstruction is therefore detected by comparing the duration of a receiver output pulse with a reference duration. This reference duration may depend on the position of the window. Further, the pulses may be generated each time the system is connected to the vehicle battery or in response to a user command.

The '854 patent also proposes detecting the ambient light using another receiver and subtracting the ambient light from the signal provided by the infrared receiver. This solution allows the effects of the ambient light on the detection process to be eliminated. One problem encountered in this type of system relates to the reliability of contactless detection. U.S. Pat. No. 5,955,854 proposes using the detection of the characteristics of the window drive motor as a fallback solution without providing any details.

U.S. Pat. No. 6,154,149 proposes using a camera mounted on the exterior rear view mirrors, coupled with pattern recognition algorithms, to detect crime. If the field of the camera covers both sides of the plane of a window, an object detected on both sides and in the travel of the window is considered an undesirable object.

U.S. Pat. No. 5,506,567 proposes using an infrared alarm for the surveillance of automobile vehicle windows. A transmitter located on the top of the pillar separating the front and rear windows generates modulated infrared beams, and the reflected pulse is received by a detector next to the transmitter. This document is limited to applications such as alarms.

Obstruction detection applies not only to windows, as explained above, but also to other types of moving, openable vehicle body parts such as, for example, power driven sunroofs.

There is a desire for a simple, reliable and effective obstruction detection system.

### SUMMARY OF THE INVENTION

In one embodiment, the invention is a system for detecting an obstruction in the path of an openable vehicle member, such as a window or sunroof. The system comprises a direct obstruction detector and an indirect obstruction detector. The indirect detector provides the direct detector with openable member position information. In one embodiment, the indirect detector is designed to detect forces exerted by the obstruction on the openable member.

The direct detector may comprise a light sensor and a circuit for conducting a timing analysis of the light received by the sensor. The analysis circuit is designed to compare the distribution of the light received by the sensor with a reference distribution. In particular, a charge-coupled sensor may be used. The direct detector is designed to detect the obstruction according to the position information provided by the indirect detector.

The invention is also directed to a method for detecting an obstruction in the path of the openable member, comprising indirectly detecting a force exerted by the obstruction on the openable member, generating openable member position information based on the detected force, and directly detecting the obstruction in the path of the openable member, based on the position of the openable member.

A light sensor may also be provided. In this case, the direct detection step comprises detecting the light along a closing line of the openable member. The direct detection step may also comprise comparing the light distribution along this line with a reference distribution and detecting an obstruction when the comparing step shows a variation.

The direct detection step may comprise updating the reference distribution based on the openable member position information. The reference distribution may then depend on the openable member position information.

An obstruction may also be detected when the comparison shows a variation above a threshold that depends on the openable member position information.

### BRIEF DESCRIPTION OF THE DRAWINGS

Other characteristics and advantages of the invention are given in the following detailed description of the embodiments of the invention, which provided by way of example only and in reference to the drawings:

FIG. 1 is a schematic representation of a vehicle door incorporating one embodiment of the invention;

FIG. 2 is an illustrative detection histogram for a sensor according to one embodiment of the invention;

FIG. 3 is a representative diagram of a detector according to one embodiment of the invention;

FIG. 4 are illustrative detection histograms according to one embodiment of the invention;

FIG. 5 is a block diagram illustrating a detection system according to one embodiment of the invention.

### DETAILED DESCRIPTION OF THE EMBODIMENTS

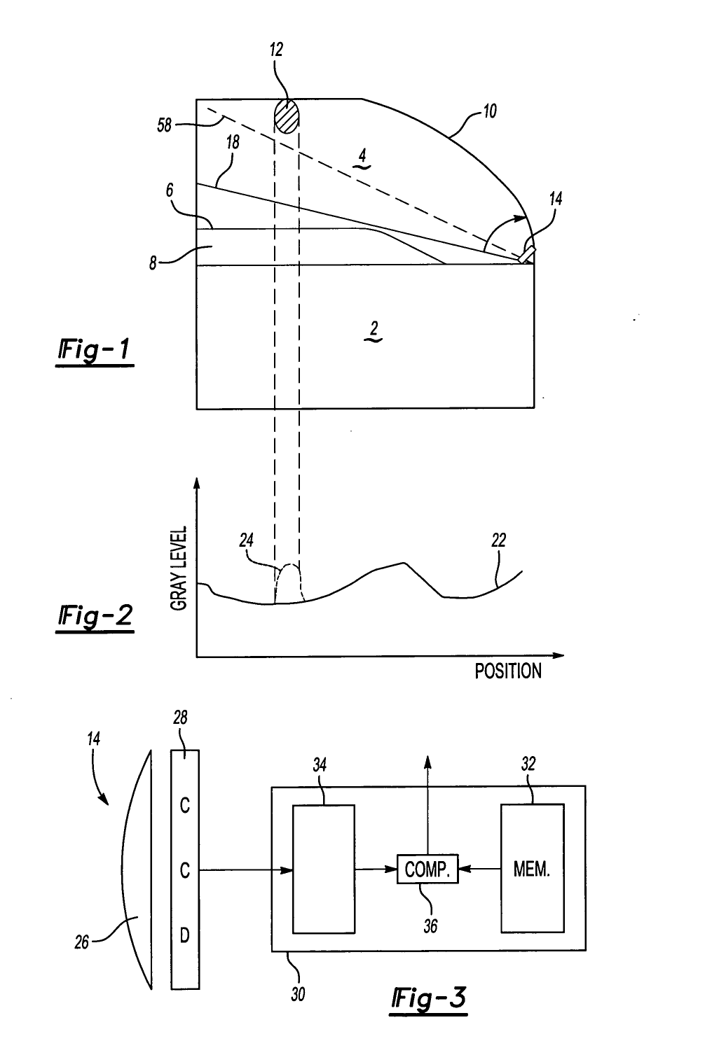

FIG. 1 is a schematic representation of an automobile vehicle door for illustrative purposes. A front door is shown in this example, but the invention is equally applicable to another door or an openable vehicle member other than a window. FIG. 1 shows a lower part 2 of the door, an opening 4 cleared by the downward movement of a window 8, and an upper edge 6 of the window 8 in a position near a fully open position of the window. An upper edge 10 of the opening 4 is shown in FIG. 1 as a bold line, and an obstruction 12 is shown in FIG. 1 near this upper edge 10. The problem lies in detecting the presence of this obstruction 12 when the window is closing so that a force greater than the maximum force permitted by safety standards is not applied to the obstruction 12.

FIG. 1 also shows an optical detector 14. The detector 14 is placed at the front lower corner of the opening 4, which corresponds substantially to a fixing point of a rear view mirror. The detector 14 monitors a substantially vertical angular area or angular sector 18. The angular area 18 covers a portion of the opening 4 delimited by the upper edge 10 on the one hand and a halfway line 18 coming from the detector 14 on the other. In other words, the optical detector 14 covers an area adjacent to the upper edge in the plane of the opening 4 or in the plane of the window 8. This is the area in which the pinching is to be detected; it is not necessary to detect the presence of an obstruction near the lower edge of the opening 4 because pinching does not occur in that area.

The detector 14 can be configured so that a selected amount such as, for example, at least 200 mm, is monitored by the detector 14 in the direction of the travel path of the window 8 before the window 8 reaches the upper edge 10. In one embodiment, the upper edge 10 is formed by a window seal in the example shown in FIG. 1. The angle of the sector 18 then depends on the position of the detector 14. Another solution is to have the detector 14 see or watch the entire upper edge 10 of the opening 4. Two or more detectors may also be used instead of the single detector 14 shown in FIG. 1.

In terms of thickness, (i.e., in a dimension perpendicular to the plane of the window 8 or the plane of the opening 4), the detector 14 advantageously monitors a distance substantially equal to the thickness of the seal (e.g., 4 to 5 cm). In other words, the detector 14 may monitor only the edge of the window 8 or opening 4 and, for example, 3 cm on each side of the edge. The volume covered by the detector 14 is substantially flat and extends around the window 8.

The detector 14 may comprise a known CCD (charge-coupled device) sensor having a lens for focusing. The lens may have an optional filtering function. In either case, the lens is placed in the path of the light received by the CCD sensor. In this way, the detector 14 monitors the angular sector 18 in the manner explained above. The picture elements or pixels of the CCD sensor used as the detector 14 each provide information about a part of the upper edge 10. The position of a pixel represents a position along the upper edge 10. The intensity or brightness for a pixel represents the edge or the presence of an obstruction in this position. In fact, as explained below, the appearance of an obstruction causes a local variation in the brightness of the pixel corresponding to the obstruction's position. From this point of view, it is particularly advantageous for detecting human obstructions, such as the driver's hand, to use a charge-coupled sensor because such sensors are particularly sensitive to infrared light. The presence of a human obstruction therefore causes a significant increase in the brightness detected by the sensor. The presence of any other type of obstruction also causes a variation in the brightness detected. This may be an increase, as for a human obstruction, or a decrease if, for example, the obstruction absorbs light.

In one example, a 128×128 pixel CCD sensor is used as the detector 14. The sensor is placed vertically, as shown in FIG. 3. A focusing lens focuses the light received by the sensor so that the sensor monitors the upper edge 10 along with an area extending 3 cm on either side of the edge in a direction perpendicular to the plane of the opening 4.

A wider sensor could also be used as the detector 14. In this case, only the pixels of the image that correspond to the upper edge need to be processed, with the neighboring pixels if necessary. This may be implemented either when the sensor is installed or by using a pattern recognition program designed to recognize the upper edge. It must be noted that the pattern recognition program can be kept relatively crude in this embodiment because it only has to recognize an a priori known pattern. In the case of an upper window seal, the edge may also have a black color that creates a stark contrast relative to the surroundings. This type of program allows for adjustment to the mounting constraints, dispersion of the door frame and sensor mounting. In a nominal situation, for example, the image of the frame is in a known position A; due to the mounting dispersions, the image of the frame may be offset and in a position B. It is thus advantageous that the system calibrates itself so that it can take correct measurements.

FIG. 2 shows an example of a detection histogram for a sensor of the type shown in FIG. 1. The position along the upper edge is shown on the x-axis along a horizontal line. Alternatively, the row of pixels could be shown on the x-axis. The two representations are similar to within one transformation if applicable; the transformation accounts for the characteristics of any lens coupled to the sensor.

The light intensity received by the sensor is shown on the y-axis. In the most simple configuration of a 128×128 pixel sensor, the light intensity may simply be an average of the light intensities of the 10 pixels in a given row along the sensor. This intensity is representative of the light received from a given position along the upper edge 10 or of the light received from a given direction. If the sensor is monochromatic, which can be sufficient for detection in one embodiment of the invention, the brightness may be expressed in the form of gray levels. The light intensity may also be integrated, if applicable, with a variable integration period as explained below.

FIG. 2 shows an example of a brightness histogram 22 when there is no obstruction in the path of the window 8. It can be seen that the brightness is not constant along the edge 10. This may be due to the lens used, a variable reflection along the edge, or simply the distance between the sensor and the edge. FIG. 2 also shows a local variation 24 in the histogram caused by the presence of the obstruction 12. As shown by the dashed vertical lines between FIGS. 1 and 2, the obstruction generates a local increase in the intensity received by the detector 14. FIG. 2 also shows an example of an increase in intensity due to a human obstruction with additional infrared light received by a CCD sensor.

Thus, an obstruction may be detected simply by detecting the variation in local light intensity on the sensor. This variation is detected relative to a reference histogram 22 like the one shown in FIG. 2. In other words, the distribution of the light received by the detector at a given moment is compared with a reference distribution. The variation in the light distribution represents the presence of an obstruction.

This solution avoids any use of pattern recognition algorithms as suggested in U.S. Pat. No. 6,154,149. As a result, the solution described above is both simpler and more reliable, insofar as it does not imply a priori knowledge of a pattern or the specific nature of the obstruction. Even if a pattern recognition program is used to identify the upper edge of the opening, this program can remain simple, as explained above. The solution is also simpler and more advantageous than the solution proposed in U.S. Pat. No. 5,506,567 or U.S. Pat. No. 5,955,854 because the invention allows, if desired, the entire upper edge 10 of the opening 4 to be monitored and not just a part of the edge 10 or discrete directions.

In one embodiment, the reference histogram 22 in FIG. 2 can be measured at different moments. A histogram generated and stored in advance by the detector manufacturer can be used. This solution has the advantage of being simple; however, it may cause problems if the detector is not assembled accurately. If, for example, the detector is offset (e.g., at an angle or in translation) the reference histogram may also be offset, leading to potential false detections. Note, however, that this is not necessarily a problem if spatial recognition of the door frame is used, as set out above.

A histogram recorded after the installation of the detector may also be used. This solution is still simple and allows for the position of the detector on assembly to be taken into account. In other words, the reference histogram in this case will be customized to the detector's specific installation position.

It is also possible to regularly or automatically update the reference histogram at selected times. Automatic updating may, for example, take place each time the system is started or each time the window is opened. This allows the aging of components, mechanical deformation, dirt, and other parameters that might affect the light detection to be taken into account.

A histogram that has just been measured may be used as the reference histogram. This solution avoids having to store a histogram permanently and simplifies the detector circuit.

FIG. 3 is a block diagram of a detector 14 according to one embodiment of the invention. In the Figure, the detector is shown with its lens 26 and the sensor 28. The information provided by the sensor 28 (e.g., an image if the sensor 28 is a charge-coupled sensor) is applied to a circuit 30. The circuit has essentially a permanent or non-permanent memory 32 to store the reference histogram, a processing module 34 that extracts a histogram from the information coming from the sensor, and a comparator 36 that compares the instantaneous histogram and the reference histogram. The comparator 36 generates a signal representing the detection of an obstruction. The possible means of updating the reference histogram and the possible pattern recognition program that can be used to calibrate the detector are not shown in the Figure, but is within the skill of those in the art.

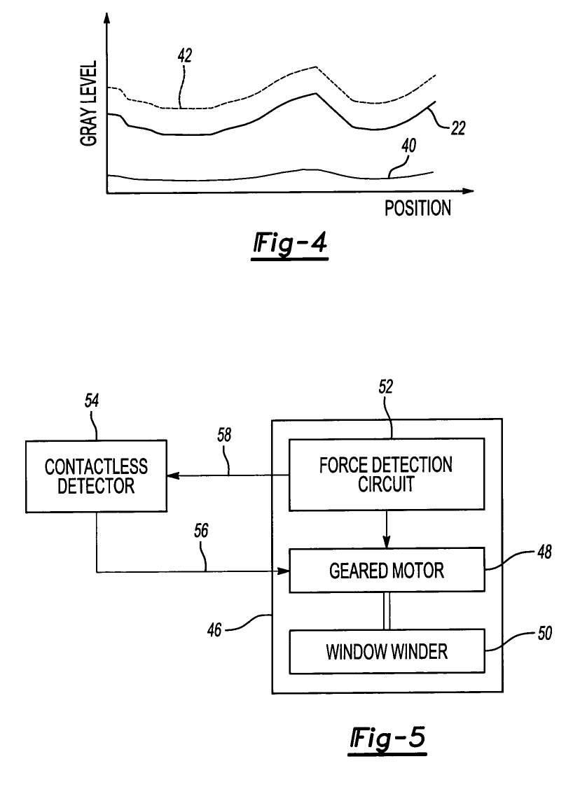

FIG. 4 shows other examples of histograms according to other embodiments. The x- and y-axes are similar to those in FIG. 2. The reference histogram 22 in FIG. 2 is shown again in FIG. 4. One of the problems that may be encountered is a drop in the light intensity received by the sensor. This drop may result in a reduction in the average gray level of the reference histogram. Such a drop may typically be encountered at night. FIG. 4 therefore shows a reference histogram 40 obtained when the light intensity is dropping. It is clear that in this case, it is more difficult to detect the presence of an obstruction.

One solution entails providing supplemental lighting to compensate for the lack of light perception on the detector in low-light environments. With a charge-coupled sensor, it is advantageous to use an infrared light source. This type of source has an advantage that it does not disturb the passengers or driver of the vehicle. Moreover, as mentioned above, the charge-coupled sensor is sensitive to infrared light. FIG. 4 shows a reference histogram 42 obtained after activation of a light source. The histogram 42 has a similar appearance to the previous reference histogram 22, but with higher gray levels. This simply represents the reflection by the upper edge of the light emitted by the source. The source may be a single or distributed source, depending on the type and position of the detector. Preferably, the light emitted by the infrared light source is prevented from reaching the detector directly. One solution comprises placing the source next to the detector 14.

Even if this type of source is present, the reflected light is not used directly for detection, and the gray level histogram is still analyzed on the detector 14. The similar appearance of the reference histograms 42 and 22, as shown in FIG. 4, illustrates that the presence of a source simply increases the ambient light.

The source may be activated when the average level of the histogram, calculated over all of the positions or on a sliding window, is lower than a given value or first threshold value. The source may be switched off when the average level, calculated in the same way, exceeds another given value or second threshold value. The source may also be switched off when the maximum value of the gray level on the histogram reaches another given value. In any case, the increase in the value may lead to saturation of the sensor. This solution simply involves adding to the processing module 34 with no need to provide another detector to specifically handle low ambient light levels. The module can then detect the light received by the sensor. In the example shown in FIG. 2, the gray levels are simply integrated over all of the possible positions.

It is also possible, in the examples shown in FIG. 2 and FIG. 4, to obtain the brightness or gray levels after integration of the values provided by the sensor. This solution has the advantage of making detection more reliable. It is thus advantageous to modify the integration time depending on the ambient brightness. If it is very bright, obstructions will produce a large, easily detectable, variation in gray levels. If the ambient brightness is lower, the variations due to an obstruction are smaller. Integration ensures that obstructions are always detected. The integration time is limited by the detection speed required, depending on the speed of movement of the window. It is also limited by the choice of the reference histogram insofar as it is measured before the start of the integration period. In practice, a variable integration time of, for example, 10 ms (e.g., the current charging time of a sensor in this example) and 800 ms can be used for the charge-coupled sensor proposed above. The first value corresponds to an instantaneous measurement of the values provided by the sensor pixels. The second value corresponds to the accumulation of the light in the photodiode over 800 ms. This value corresponds substantially to the time during which the maximum charge is reached in the sensor.

The detector 14 positioned in FIG. 1 may be used as follows in one example of the invention. When automatic closing of the window is activated, the gray level histogram is recorded on the charge-coupled sensor, which acts as the detector 14, for a period of, for example, 50 ms. The histogram just obtained, or the current histogram, is then compared with the previous histogram, or a reference histogram. If the variation between the current histogram and the reference histogram exceeds a threshold, the movement of the window is stopped and the automatic closing mode is inhibited. The window can still be closed in a manual mode by pressing and holding down a close button. Automatic mode is enabled again when the window reaches the upper edge of the opening.

The detector described in reference to the above figures provides a simple and reliable solution for the detection of obstructions in the path of an automobile vehicle openable member. It can be made even more reliable, as will now be discussed. FIG. 5 shows a block diagram of an obstruction detection system according to another embodiment of the invention. FIG. 5 shows an openable member drive system 46. This drive system 46 typically comprises a geared motor 48 that mechanically drives a window winder 50. The drive system 46 also comprises a force detection circuit 52, which is able to interrupt the drive of the window winder when an obstruction is present. This circuit does not detect the obstruction directly, but detects the presence of the obstruction indirectly; it can therefore be classified as an indirect detection circuit. In fact, the force detection circuit 52 operates by detecting a force greater than a nominal permissible openable member closing force and detects the force exerted by the obstruction on the openable member.

Tension detectors in the window winder cables may be used, as described in FR-A-2 693 535. The operating parameters of the geared motor, such as voltage and current, may also be measured to deduce the torque exerted by the geared motor. In either case, the force detection circuit only interrupts the movement of the openable member when the openable member has met the obstruction and exerted a non-zero force on it.

FIG. 5 further shows a contactless detector 54. This detector may be of the type discussed above in reference to FIGS. 1 to 4. For example, when the detector 54 identifies an obstruction in the path of the openable member, it sends an interruption command to the geared motor, as represented by the arrow 56 in FIG. 5. The detector 14 directly detects that the obstruction is present; it can therefore be classified as a direct obstruction detector or direct detection circuit.

When an obstruction is present, the contactless detector 54 emits a openable member movement interruption signal if it detects the obstruction. If no obstruction is detected, the indirect detector can interrupt the movement of the openable member when the force exerted on the openable member by the obstruction is detected. In other words, the commands given by the detectors undergo a logic OR function.

In the embodiment shown in FIG. 5, the drive system also provides openable member position information. This position information is typically provided by the force detection circuit and may be derived from the measurement of the number of revolutions of the geared motor or the measurement of the geared motor operating time. A specific sensor may also be used on the geared motor. The provision of such position measurement is known and is within the scope of a person skilled in the art.

This openable member position information is applied to the contactless detector 54 as shown by the arrow 58 in FIG. 5. It can therefore be used to improve the operation of the contactless detector, as the contactless detector can then take into account the openable member position according to one or more of the embodiments noted above.

In one embodiment, the position information is used to adjust the detection threshold. At the start of travel of the openable member, it is possible to set a higher detection threshold; in other words, the movement of the openable member will only be interrupted if the obstruction is detected with high probability. On the other hand, at the end of travel of the openable member, the time available for the obstruction to be removed decreases. The detection threshold can therefore be reduced, and a stop in the movement of the openable member may be accepted more easily even if there is no obstruction (false positive).

From a practical point of view, in the example shown in FIGS. 1 to 4, the threshold above which a variation in the histogram is interpreted to indicate an obstruction can be varied depending on the position of the window. At the start of the travel of the window, an obstruction would only be detected if the variation in the histogram exceeds a first threshold value. At the end of the travel of the window, an obstruction would only be detected if the variation in the histogram exceeds a second threshold value, lower as an absolute value than the first threshold value. Of course, two threshold values are given as an example, but any number of threshold values or even a continuously variable threshold could be used depending on the window position.

As explained above, the values provided by the sensor may also be integrated. As noted above, the integration time be varied depending on the ambient brightness. The integration time may also be varied depending on the openable member position. At the start of the closing travel, a longer integration time is selected than the integration time at the end of the closing of the window. As in the previous example, this has the effect of making the contactless detection more sensitive at the end of the closing travel than at the start of the closing travel.

In another embodiment, the position information may be used to trigger or control the updating of the reference histogram. Thus, the reference histogram can be updated each time the openable member is opened, as explained above. The position information can be used to determine the opening. The update can also be controlled on the basis of the position information. Thus, it may be advantageous for the histogram to be updated only when the openable member is in an open position because this prevents the reference histogram from being modified by the presence of the openable member. In this case, before the periodical or automatic updating of the reference histogram, the window is checked to see if it is in an open position and the update will only take place if it is. The reference histogram may also be updated only if the openable member is closed; this has the advantage that the detection takes into account the light variations caused by the presence of the openable member. Similarly, the position information in this case is useful to trigger or control the updating of the reference histogram.

In another embodiment, the position information is used to choose one detection histogram out of several available histograms. Thus, in reference to the diagram in FIG. 1, it can be seen that over the start of the travel of the window, it the angular sector between the half lines 18 and 58, the presence of the window does not change the way in which the detector 14 sees the upper edge 10. On the other hand, when the window 8 enters the area delimited by the upper edge 10 and the half line 58, the image of the window 8 can be superimposed locally on the image of the upper edge seen by the detector 14. The availability of position information enables the detector 14 to adjust the reference histogram as a result of the window's changed position. For example, the histogram variations caused by the presence of the openable member can be calculated or simulated and not taken into account in the detection. This amounts to modifying the reference histogram depending on the position.

In another embodiment, the position information is used to modify the monitored area. At the start of the closing travel of the openable member, the monitored area can be centered on the upper edge and only extend slightly beyond the upper edge. This prevents false positives from occurring when the passenger places his arm near the window without passing it through the opening 4. At the end of travel, the monitored area can be wider, which allows for the presence of an obstruction to be detected more quickly. In practice, in the example of the charge coupled device sensor mentioned above, this can be achieved by simply modifying the number of pixels on which the gray levels are measured as a function of the position information.

More generally, it can be seen that the position information can be used for all of the operating parameters of the contactless detector. The different embodiments described may be used as alternatives or combined into a single system.

The example of the detector described in reference to FIG. 5 combines the advantages of contactless detection and force detection. During normal operation, the detection is carried out by the contactless detector 54. Detection therefore takes place before the openable member even comes into contact with the obstruction, allowing the openable member to be stopped quickly with no pinching force on the obstruction. Because the contactless detection takes the position of the openable member provided by the drive system 46 into account, it is more accurate and reliable than currently known systems. Further, even if the contactless detector 54 does not identify the obstruction, the movement of the window can still be interrupted by the drive system 46.

Of course, this invention is not limited to the embodiments described above by way of example. For example, the embodiments described above focus on a door and a window, but the invention can also be applied to any openable member, such as a sunroof for example. In this case, the term “upper edge” used above may be replaced by the term “closing contact line” of the openable member, as a vehicle roof rather than a door. Both the vehicle roof and vehicle door are examples of parts with an opening and a moving openable member in such opening and are within the scope of the invention.

FIG. 5 describes the use of a contactless detector of the type shown in FIGS. 1 to 4. Other types of contactless detector could also be used, taking into account the window position information.

For the embodiment of the obstruction detection system in FIG. 5, departures may be made from the block diagram. Thus, to make the explanation clearer, the contactless detector is separated in the figure from the drive system 46 force detection circuit. However, a single logic circuit may be used both to control the optical sensor used for the contactless detection and to monitor the geared motor.

It should be understood that various alternatives to the embodiments of the invention described herein may be employed in practicing the invention. It is intended that the following claims define the scope of the invention and that the method and apparatus within the scope of these claims and their equivalents be covered thereby.

1. A system that detects an obstruction in the path of an openable vehicle member, comprising:
a direct detector that directly detects the obstruction;
an indirect detector that indirectly detects the obstruction and outputs openable member position information to the first detector.

2. The system of claim 1, wherein the indirect detector detects a force exerted by the obstruction on the openable member.

3. The system of claim 1, wherein the direct detector comprises:
a light sensor that receives light in a vicinity of the obstruction; and
an analysis circuit that conducts an analysis of light received by the light sensor.

4. The system of claim 3, wherein the analysis circuit conducts the analysis by comparing the distribution of the light received by the light sensor to a reference distribution.

5. The system of claim 3, wherein the light sensor is a charge coupled device sensor.

6. The system of claim 1, wherein the direct detector detects the obstruction according to the position information provided by the indirect detector.

7. A method for detecting an obstruction in the path of a openable member, comprising:
indirectly detecting the obstruction by detecting a force exerted by the obstruction on the openable member using an indirect detector;
outputting openable member position information; and
directly detecting the obstruction in the path of the openable member based on the openable member position information.

8. The method of claim 7, wherein the step of directly detecting the obstruction comprises detecting a light distribution along a closing line of the openable member.

9. The method of claim 8, wherein the step of directly detecting the obstruction comprises:
comparing the light distribution along the closing line with a reference distribution; and
indicating a presence of the obstruction when the comparison step shows a variation between the light distribution and the reference distribution.

10. The method of claim 9, wherein the step of directly detecting the obstruction further comprises updating the reference distribution based on the openable member position information.

11. The method of claim 9, wherein the reference distribution is based on the openable member position information.

12. The method of claim 9, wherein the indicating step indicates the presence of the obstruction when the comparing step shows that a variation between the light distribution and the reference distribution is greater than a predetermined threshold.

13. The method of claim 12, wherein the predetermined threshold is variable based on the openable member position information.

14. An anti-trapping system for an openable vehicle member, comprising:
a drive system that controls movement of the openable vehicle member;
an indirect detector that detects a force exerted by the obstruction on the openable member; and
a direct detector comprising
a light sensor that detects a light distribution affected by the obstruction and receives openable member position information from the indirect detector, and
an analysis circuit that conducts an analysis of light received by the light sensor and outputs an interruption signal to the drive system to stop movement of the openable vehicle member if the obstruction is detected.

15. The system of claim 14, wherein the analysis circuit conducts the compares the distribution of the light received by the light sensor to a reference distribution.

16. The system of claim 14, wherein the light sensor is a charge coupled device sensor.

17. The system of claim 14, wherein the direct detector detects the obstruction according to the openable member position information provided by the indirect detector.
